(19) United States
(12) Patent Application Publication
(10) Pub. No.: US 2006/0036731 A1
(43) Pub. Date: Feb. 16, 2006

(54) Novel method and system of keyless data entry and navigation in an online user interface console for preventing unauthorized data capture by stealth key logging spy programs

(75) Inventors: Donald James Mossman, Blackstone, MA (US); Fazal Raheman, Nagpur (IN)

Correspondence Address: Donald J Mossman, 30 Liberty Hill Dr, Blackstone, MA, 01504, US

(73) Assignee: Mossman Associates, Blackstone, MA (US)

(21) Appl. No.: 10/918,797

(22) Filed: Aug. 16, 2004

(51) Int. Cl. G06F 15/173; G06F 15/16

(52) U.S. Cl. 709/225; 709/229

(57) ABSTRACT

Every secure Website provides Secure Socket Layer (SSL) connectivity to prevent user's confidential information from network sniffers. However, in recent times keyboard sniffing has become the preferred mode of stealing user information. Keystrokes capturing is a security hole in front of SSL, for which there is no effective solution. The invention describes a novel method of securing user information from all types of software and hardware keyloggers. The method requires no software installation on user's PC, and comprise of remote executable application embedded on a Web page.

### BACKGROUND OF THE INVENTION

According to latest global population surveys, there are currently about 800 million Internet users worldwide and the global Internet audience has not yet reached a plateau in the growth curve. As much as the Internet is growing, the use of Web Applications for remote data access is increasing. With the increasing E-commerce and Web Mail Applications, concerns for security on the Internet are growing. Today's Internet security practices, which focus on protecting the remote servers, are not adequate in preventing client-end intrusion of hackers into client PCs. Every secure Website uses SSL (Secure Socket Layer) encryption protocol to connect the user's PC with its Secure Server. SSL provides security in two ways, the first in the form of a certificate of authenticity of the remote server to the user, and second, in the form of 128 bit encryption of the data transmitted from Website's remote user interface to the Server. Thus SSL tunnels the user information from user's data port to the Website's Data Server and therefore secures the information from network sniffers. However, SSL provides no protection against keyboard sniffers, which hijack the data even before SSL encrypts the data. Stealth keylogger spy programs offer the greatest threat to such client-end security issues. In recent times Internet resources have been flooded with information on keylogging, and common man's accessibility to such keyloggers is very easy. There are hundreds of keylogging programs freely available on the Internet for anyone who desires to plant a data-monitoring spy in his victim's personal computer. There are software keyloggers and hardware keyloggers. Most of the software keyloggers are stealth programs that can be installed remotely on any PC, which connects to the Internet. Most users use two basic methods to secure their PCs, (a) Antivirus packages and (b) Firewalls. Both these methods are quite effective and should be used by every user. However, they still remain imperfect and do not offer much protection against the keystroke sniffing stealth spy programs. For instance, antivirus packages often either ignore keyloggers, or do not have information about one or another particular variety of keylogger in its signature database. Firewall may not stop a keylogger, which is often delivered to the user camouflaged as legitimate data packets requested by the user himself. A violator can also plant the keyboard sniffer without using a network.

There are a few anti-keylogger programs available which can protect the PC against some of the software keyloggers. But there is none that can detect or offer prevention against all the types of software keyloggers or hardware keyloggers. These anti-keylogger programs, though of limited utility in protection against known software keylogger signature bases, they offer little protection against kernel based software keyloggers, and absolutely no protection against the hardware keyloggers. The instant invention provides a method for the content providers to offer 100% protection against all types of known and unknown keylogging intrusions to their customers during the customer's online transaction on their website. The novel embodiments of the invention do not require the end users to install any software on their computers. The specification of the instant invention is described herein.

### BRIEF SUMMARY OF THE INVENTION

The embodiments of the instant invention describe a novel approach to plug the security hole in front of the SSL (Secure Socket Layer) in a secure client-server transaction by overcoming the capturing of the Keystrokes by the stealth key-logging spy programs. Accordingly, it is a primary object of the invention to prevent intrusion of unauthorised users into a Web Application by preventing theft of sensitive user information from user's PC during a Web transaction. It is also an object of the invention to prevent data capture in front of the SSL in a secure World Wide Web client-server transaction. It is a specific object of the invention to prevent keystroke capture by keylogger programs during the period the user inputs sensitive information on a Web page. It is also an object of the invention to overcome all the keystroke capturing methods known to prior art. It is also an object of the invention to provide such protection without any need for software installation on the user's PC. Hence it is another object of the invention to provide such client-end anti-keylogger protection algorithm within a server executed client-delivered Web page itself.

The invention is preferably implemented in a computer having a processor and resident memory, with a modem, an operating system, a graphical user interface, a Web browser, a telephone or cable connection, and an Internet access account. According to the preferred embodiment, there is described a method of conducting a secured transaction by preventing keystroke capturing programs from stealing the confidential user information entered on a Web page. The method begins with a client's HTTP request for a secured Web page from a remote server. The secured Web page, so delivered to the client, opens up in a Web browser window. Such secured web page contains data fields for entering user information for authenticating the user. In the preferred embodiment such data fields are included in a Console, which also has a virtual keypad with all the necessary alphanumeric and function keys. The user uses the virtual keys in the console instead of the hardware keyboard to enter his confidential information. The console of the instant invention is a platform independent, remotely executable, software application embedded in a Web page, which provides keyboard device input functionality, but without using the operating system's keyboard character generation protocol sequence. Thus it skips the different points in standard keystroke processing route, which the different keyloggers use to capture the data before it reaches the computer's display device.

The virtual keys are operated by a mouse event, such as “mouse-click” or “mouse-over”. The point in space location of the mouse cursor in the applications display area is codified to a specific character. Such character is directly displayed in a data display field, on a mouse event pointing to that specific location. The user's operating system cannot discern the unique characters associated with the mouse cursor location in application display area, hence making it impossible to capture a character associated with any particular mouse event within the application's console area.

In an embodiment of the instant invention, the remote executable application comprises of a server executable data entry virtual keypad and the data input fields within a virtual Console, embedded in a Web page, located on a remote server, at specified URL location, requested by a client computer via a Web browser using the HTTP or any Web-compatible protocol.

The Console algorithm is written in a remotely executable platform independent programming environment such as JAVA, CGI, Flash etc. The Console is loaded on the client machine as remote executable program embedded in a Web-compliant page such as an HTML or XML page. All of the prior virtual keyboards are described as client resident programs, which bring a parallel target application in focus to type the characters in that application.

In another embodiment there maybe a Data Export Module, which copies/exports/feeds the characters generated within the data output module to the equivalent data fields in another open page of the Web Browser. In yet another embodiment of the invention the alphanumeric characters are randomly assigned to the Information Keys with each fresh client request for the Web page. In yet another embodiment the alphanumeric characters are not displayed in a keypad fashion, but scroll within a mouse controlled scrolling window.

### BRIEF DESCRIPTION OF THE SEVERAL VIEWS OF THE DRAWINGS

FIG. 1 is a schematic diagram of the user interface Console of the instant invention.

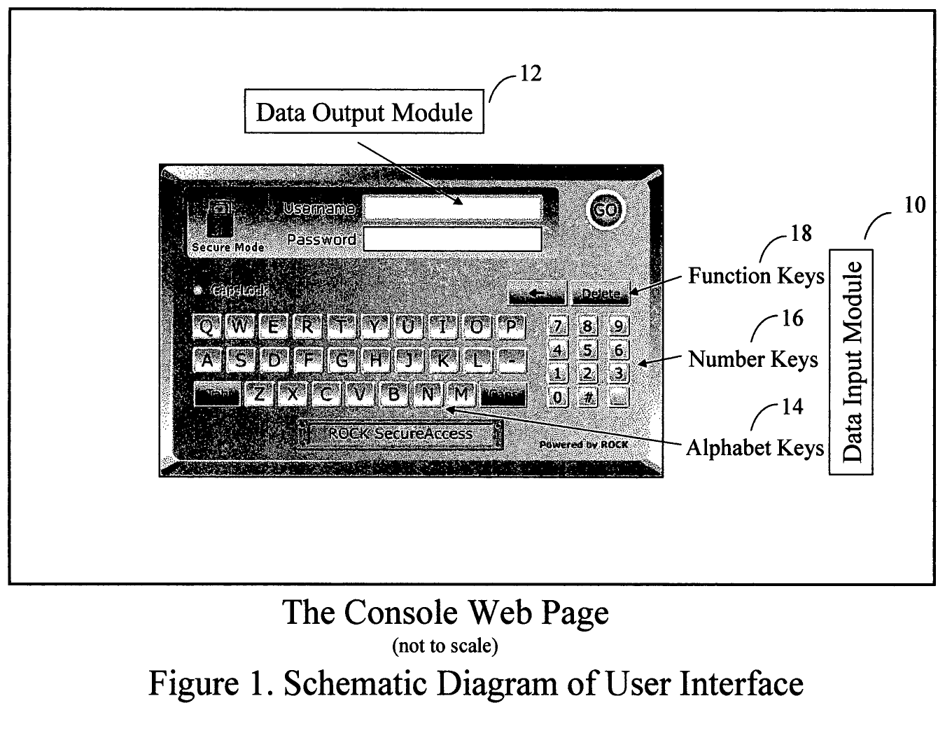

FIG. 2 is a block diagram of the preferred embodiment of the invention.

FIG. 3 is a block diagram of another embodiment of the invention.

### DETAILED DESCRIPTION OF THE INVENTION

The preferred embodiment of the present invention is described as a Client-Server solution for enhancing security of Web transactions. The preferred embodiment is a software algorithm having at least two functional modules integrated within a single server executable application embedded in an HTML or XML page. The preferred embodiment comprises of a Data Input Module 10 and the Data Output Module 12. Both the Data Input Module and the Data Output Module are located within a single user interface console on a server executed web page. The Data Output Module comprises of one or more data output fields, which are populated by the activation of the soft alphanumeric screen keys within the Data Input Module/Information Keys Module by a mouse event. Such mouse event can be a standard “mouse-click” event, or a “mouse-over” event.

The Data Input Module/Information Keys Module comprises of virtual on screen Information Keys and Function Keys. Such Information Keys and Function Keys are provided for data input and navigation. The Information Keys are alphanumeric keys comprising of Alphabet Keys 14 and Numeric Keys 16. Each alphabet key is assigned to one of the 27 alphabets arranged in preferably the conventional QWERTY keyboard fashion. Each Number Key is assigned to numbers from 1 through 0. The Function Keys 18 include Caps Lock, which allow the keys to type upper case alphabets and the Backspace, Delete, Tab, Enter keys permit correction and navigation of the data fields. The mouse cursor is used for data input and navigation. If the input key is the information key or a combination of alphabet key and Caps Lock Function Key, a code corresponding to the information key is generated and, if the input key is a Function Key then a corresponding function is executed. All the characters and their corresponding codes used for display in the display field are stored and compiled within the remotely executed applet on the Web page, neither importing any data or resources from the host computer, nor permitting an export of mouse event related information or function codes to external client resident applications. The Data Input Module algorithm disables 20 the computer's PS/2 or USB keyboard device input 22, and permits exclusively the mouse-event input data via the virtual Information and Function Keys. The Data Output Module receives and displays within the data display fields 24 the information key codes as alphanumeric characters. On clicking the Enter/Go/Submit key 26, the Data Output Module establishes an SSL connectivity 28 with the remote server 30 and delivers the encrypted data to the remote server. The preferred embodiment thus protects the sensitive user information from any kind of keystroke capturing software program or hardware device.

In another embodiment, the Data Output Module does not directly establish SSL connectivity to the remote server, but delivers the data field display alphanumeric characters to the Data Export Module 32. The Data Export Module searches for another open but tiled out-of-focus browser window containing equivalent data display fields, and brings the target page into focus, and thereafter populates the target page data output display fields with the identical alphanumeric characters 34, as originally entered using the alphanumeric keys of the Data Input Module. The information thus populated in the target window/page is then delivered to the Remote Server using its own data handling resources.

In one variant of the two preferred embodiments, the distribution of alphanumeric characters within the Data Input Module is not constant as in QWERTY keyboard or in any predefined keyboard layout. In such an embodiment the alphanumeric characters are randomly assigned to the Information Keys of the Data Input Module each time the user calls the Web page. The alphanumeric character represented by each Information Key is accordingly deciphered and displayed in the data display fields by the Data Output Module in a manner as described in the preferred embodiment.

In yet another variant of the preferred embodiment, the Data Input Module comprises of the Information Keys that are not displayed in the form of a keypad but are scrolling in a mouse navigated scrolling window. The alphanumeric characters in such an embodiment are selected from the scrolling characters by a mouse event, such as mouse click.

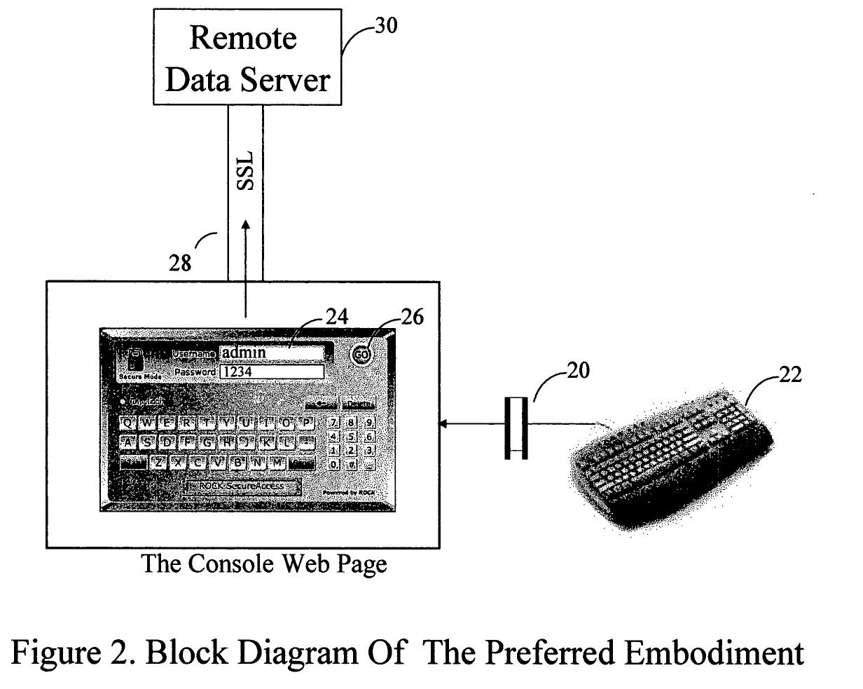

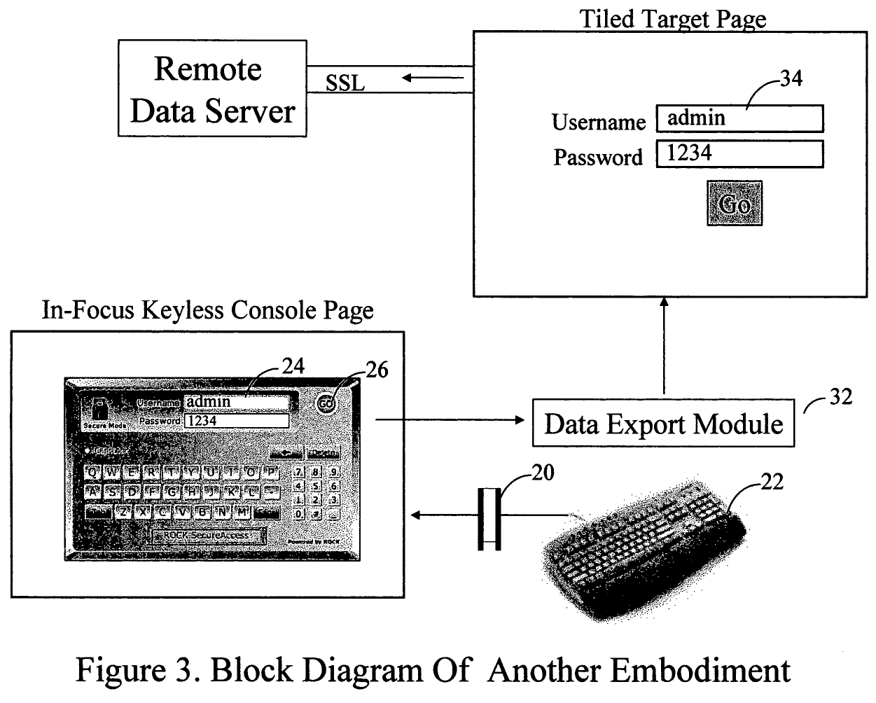

FIGS. 2 and 3 illustrate the flow diagram of practical implementation of the preferred embodiments in terms of user navigation prior to user information is authenticated by the remote server. The other variants of the preferred embodiment discussed herein, can also be easily understood from these practical implementations of the preferred embodiments.

Thus, as illustrated in the above detailed description of the invention and the flow diagrams, an online transaction on the Internet is secured by means of a platform-independent application Console, which can be operated from any PC having a Web browser with any standard operating system, without the need of any special hardware or software. According to the teachings of the preferred embodiment of the present invention, such a method of data input will virtually eliminate any unauthorized access to user information and ensure a high level of security and privacy in all transactions conducted by using the method of instant invention.

In another preferred embodiment of the present invention the security from keystroke capture can be provided from one Web page having the novel embeded Console to another tiled Web page in the same browser by exporting the Console data fields to the tiled page data fields.

In another embodiment the layout distribution of alphanumeric characters in Data Input Module is not constant, but randomly assigned to each Information Key in the Data Input Module, every time the user requests the Web page. In yet another embodiment the Data Input Module displays the alphanumeric characters in a mouse-controlled continuosly scrolling window instead of a virtual keypad.

Different embodiments of the present invention are specifically illustrated and described herein. However, it will be appreciated that modifications and variations of the present invention are covered by the above teachings. While the preferred embodiments of the present invention have been illustrated in detail, it should be apparent that modifications and adaptations to those embodiments may occur to one skilled in the art without departing from the scope of the present invention as set forth in the following claims.

What is claimed:

1. A platform independent server executable, http-compliant, user interface Console embedded in an HTML/XML Web page, providing online PC users protection against keystroke capturing spy programs and comprising of an integrated Data Input Module and Data Output Module.

2. The software algorithm of claim 1, wherein the Console application is encoded using platform independent server executable programming environment such as java, CGI, Macromedia Flash etc.

3. The Data Input Module of claim 1, wherein the Data Input Module comprises of virtual soft Information Keys and Function Keys for data input and navigation.

4. The virtual Information Keys of claim 3, wherein such Information Keys encode alphanumeric characters and Function Keys encode navigation functions such as Backspace, Delete, Tab, Caps Lock, Enter etc.

5. The user interface Console of claim 3, wherein the Information and Function Keys are activated by a mouse event such as “mouse-click” or “mouse-over”.

6. The Data Input Module of claim 1, wherein the each Information Key is randomly assigned to a new alphanumeric character each time the user requests the Web page.

7. The Data Input Module of claim 1, wherein the alphanumeric characters are not provided in keypad layout but displayed within a cursor-responsive scrolling window.

8. The Data Output Module of claim 1, wherein one or more data fields are provided to populate the data from the Data Input Module.

9. The Data Output Module of claim 1, wherein the Module disables the computer's keyboard data input protocol.

10. The Data Output Module of claim 1 wherein the data populated in the data display fields—in response to a mouse event—is delivered to the remote server using a Secure Socket Layer (SSL) connection.

11. The Console of claim 1 wherein the Data Input Module is collapsible allowing the user an option to populate the data fields using standard hardware keyboard.

12. A platform independent server executable, http-compliant, user interface Console embedded in an HTML/XML Web page, providing online PC users protection against keystroke capturing spy programs and comprising of an integrated Data Input Module and Data Output Module and a Data Export Module.

13. The software algorithm of claim 12, wherein the Console application is encoded using platform independent server executable programming environment such as java, CGI, Macromedia Flash etc.

14. The Data Input Module of claim 12, wherein the Data Input Module comprises of virtual soft Information Keys and Function Keys for data input and navigation.

15. The virtual Information Keys of claim 14, wherein such Information Keys encode alphanumeric characters and Function Keys encode navigation functions such as Backspace, Delete, Tab, Caps Lock, Enter etc.

16. The user interface Console of claim 15, wherein the Information and Function Keys are activated by a mouse event such as “mouse-click” or “mouse-over”.

17. The Data Input Module of claim 12, wherein each Information Key is randomly assigned to a new alphanumeric character each time the user requests the Web page.

18. The Data Input Module of claim 12, wherein the alphanumeric characters are not provided in keypad layout but displayed within a cursor-responsive scrolling window.

19. The Data Output Module of claim 12, wherein one or more data fields are provided to populate the data from the Data Input Module.

20. The Data Output Module of claim 12, wherein the Module disables the computer's keyboard data input protocol.

21. The Data Export Module of claim 12, that is activated by a mouse click on “Go”, “Enter” or “Submit” button of the console, in response to which the data populated in the data display fields of Data Output Module is captured for delivery to another open but tiled Web page with equivalent data fields.

22. The Data Export Module of claim 12, which on activation searches for an open Web page with equivalent data fields, brings such page into focus, and populates the page with the captured data.
